(19) United States
(12) Patent Application Publication
(10) Pub. No.: US 2004/0203594 A1
(43) Pub. Date: Oct. 14, 2004

(54) Method and apparatus for signature validation

(76) Inventors: Michael Kotzin, Buffalo Grove, IL (US); William P. Alberth, Crystal Lake, IL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/217,087

(22) Filed: Aug. 12, 2002

(51) Int. Cl. H04B 1/38

(52) U.S. Cl. 455/411; 455/566; 455/558; 455/406; 455/550.1

(57) ABSTRACT

Methods and apparatus for authenticating a signature are disclosed. A disclosed method includes receiving a signature at a wireless mobile station. The received signature has a first characteristic. The first characteristic of the received signature is compared to a first characteristic of a stored signature. The stored signature is stored in a memory of the wireless mobile station. If the first characteristic of the received signature matches the first characteristic of the stored signature, a signal is transmitted. The signal verifies the authenticity of the received signature. A disclosed apparatus includes a memory that stores a signature having a first characteristic, a receiver to receive a signature having a first characteristic, a comparator that compares the first characteristic of the stored signature to the first characteristic of the received signature, and a transmitter that transmits a signal verifying the authenticity of the received signature if the first characteristics of the stored signature and the received signature match.

### TECHNICAL FIELD

The invention relates generally to signature recognition, and more particularly to a method and apparatus for validating the authenticity of a received signature.

### BACKGROUND OF THE ART

A person's signature remains a key element of most traditional commercial transactions. For many forms of commercial transactions, such as credit card, debit card and check, a customer has to give his or her signature for approval to transfer the customer's funds to the vendor. In addition, a person's signature is used in a vast number of other circumstances where authenticity of the signature is important, such as receiving a package, withdrawing funds at a bank, etc. A person's signature is a characteristic that is unique to the individual. For example, characteristics such as a person's handwriting style, shape, direction of the stroke, slope of the letters, loops or spacing in letters, points, cross-strokes, etc. are behavioral and all contribute to the uniqueness of a person's signature. Other biometric characteristics can include speed, pressure, pen pressure, timing, etc. These biometric characteristics reflect the motion of the person's hand in creating the signature and describe how the signature was made, not just what it looks like. While the way a signature looks may be duplicated to a certain degree of accuracy, it is generally very difficult to duplicate how a signature is made using the same movements the original user uses, thereby making the characteristics of the signature unique to the user. A person's signature is therefore very specific to the person and cannot be easily duplicated unlike personal passwords or codes for example.

In everyday transactions, signatures are usually verified by someone who is receiving the person's signature. For example, in a commercial transaction at a store, a cashier may review the person's signature to verify authenticity by comparing the signature to a pre-written signature such as on the back of a credit card or on a driver's license. However, the cashier may not be trained in the subtleties of signature recognition such as the characteristics unique to a person's signature as described above. More likely, the cashier will only give a cursory comparison of the person's signature or fail to perform a comparison at all. Failure to check signatures or to recognize certain characteristics of a person's signature allows a purchaser to use a stolen credit card, bank card, etc. and falsify the signature. Even if the cashier checks the signature with the back of the card, the purchaser may be able to duplicate the signature to an extent sufficient to deceive the cashier, because the cashier can only review the look of the signature, and not the dynamics of the signature (i.e., how the signature was made). Some commercial transactions no longer even require a signature to transfer funds, such as Internet purchases or radio frequency identification (RFID) technology which withdraws funds directly from a credit card account or bank account.

Given a cashier's inexperience in authenticating signatures or failure to verify the signature's authenticity, many retailers and other signature recipients keep a copy of the receipt with the customer's signature. Some vendors even store the signature electronically by having the customer sign on a touch-sensitive pad which electronically stores the signature as a signature template in a database. If there is ever a discrepancy, for example if the owner of the credit card disputes a particular charge or transaction, the store may retrieve the receipt and compare the signature template to that of the owner. However, more often than not, once the owner discovers that the card was stolen or otherwise notices the discrepancy, the perpetrator is already gone and the damage to the owner's credit can be extensive. Other times, the owner may not even notice that his card or card number has been stolen. Furthermore, storing the signature electronically in the store's database is highly susceptible to theft and customer paranoia. Paper copies are even more susceptible to theft. Essentially, this is a reactive approach to a forged signature as opposed to a proactive approach of refusing authorization for the transaction due to an invalid signature.

Thus there is a need for a method and apparatus that provides a proactive approach to signature verification and avoids human error.

### BRIEF DESCRIPTION OF THE DRAWINGS

FIG. 1 is a diagram illustrating a disclosed system for receiving and authenticating a signature;

FIG. 2 is a flowchart illustrating a disclosed method for receiving, comparing and verifying a signature;

FIG. 3 is a diagram illustrating a disclosed system for receiving, comparing and verifying a signature;

FIG. 4 is a flowchart illustrating a disclosed method for storing a signature;

FIG. 5 is a flowchart illustrating a disclosed method for receiving a signature;

FIG. 6 is a flowchart illustrating a disclosed method for comparing a receiving signature to a stored signature; and

FIG. 7 is a flowchart illustrating a disclosed method for verifying the authenticity of a received signature.

### DESCRIPTION OF THE PREFERRED EMBODIMENTS

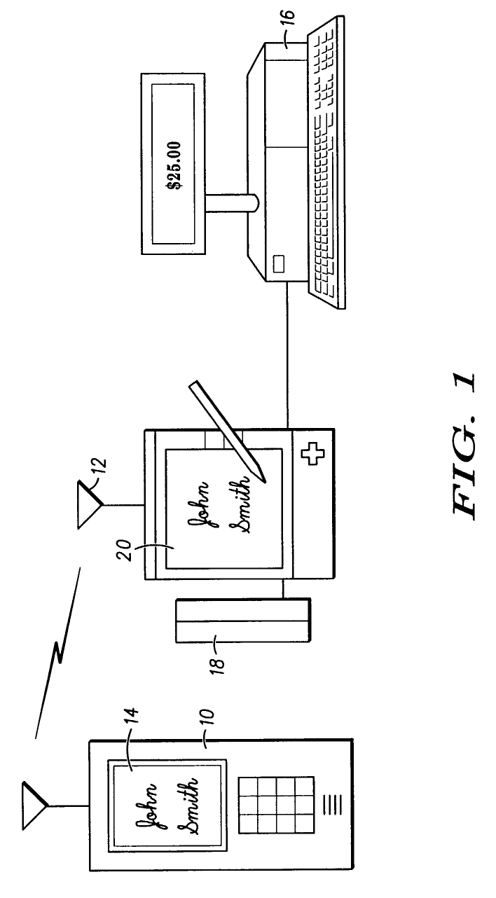

Referring now to FIG. 1, a system for validating a person's signature is shown.

The system generally includes a wireless mobile station 10 and a transponder 12 capable of wireless data transmission. The mobile station 10 may include a portable computer, a cellular telephone, a personal digital assistant, a pager or any other device that includes a memory and is capable of wireless communication. The wireless mobile station 10 may further include a memory, a processor and a touchpad 14. The touchpad 14 is capable of reading a person's signature, including not only how the signature looks but also how the signature is written. Therefore the touchpad 14 may read characteristics of a person's signature including how much pressure the person uses, at what points the pressure is applied, how fast the signature is written or how the speed may vary over the course of writing the signature, etc.

The transponder 12 is capable of receiving and transmitting wireless data communications to and from the wireless mobile station 10. While this disclosure may refer to the use of a transponder 12, the teachings of this disclosure are equally applicable to any type of receiver/transmitter capable of wireless data communications. The use of the term “transponder” is only for the sake of convenience and is only meant to be an example of what may be used for receiving and transmitting data. The transponder 12 may be communicatively coupled to an electronic database, a processor, a network or a communications system that interconnects with a central computer or other transponders 12. In one example, the transponder 12 is communicatively coupled to a processor 16. The transponder 12 may also be coupled to a device for performing an electronic transaction such as a magnetic strip reader 18 for reading credit cards and the like. The transponder 12 may also be embodied in or communicatively coupled to a computer involved in transactions over a network that require a signature, such as Internet purchases using a credit card or online bank account. In another example, the transponder 12 is communicatively coupled to a touch-sensitive pad 20 or other signature input device for receiving a person's signature. The touchpad 20 may be capable of reading a person's signature in ways similar to that of the touchpad 14.

The wireless mobile station 10 and the transponder 12 are generally in short-range wireless communication with each other. The wireless communication may be achieved through cellular communications, Infrared Data Association (IrDA), Bluetooth or any other form of wireless communication between two devices, as understood by those of ordinary skill in the art of wireless communications.

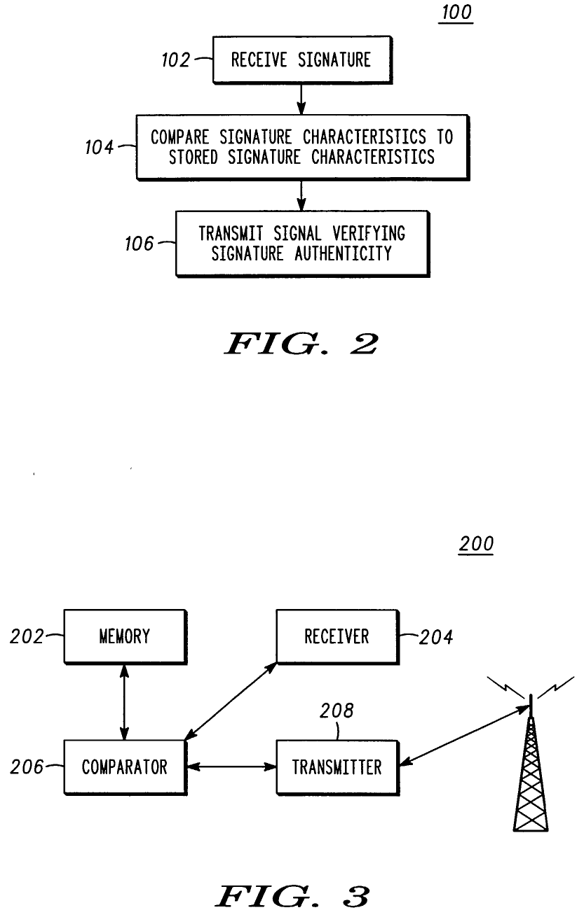

A method 100 of verifying a person's signature is shown generally in FIG. 2. Although the method 100 is particularly well suited for verifying a person's signature at a checkout terminal in a store as part of a commercial transaction, persons of ordinary skill in the art will readily appreciate that the teachings of the instant disclosure are not limited to any particular type of transaction requiring a signature. On the contrary, the teachings of this disclosure may just as easily be applied to Internet transactions where an independent person, such as a cashier, is not available to verify the signature. The method 100 may also be applied to other instances requiring signature verification such as receiving a package or signing documents. Thus, although the method 100 will be described below primarily in relation to a transaction at a checkout terminal, persons of ordinary skill in the art will readily appreciate that the method could likewise be used with the Internet, self-service stations, package receiving and shipping, documentation, etc.

Generally, the method 100 receives a person's signature at the wireless mobile station 10 at block 102. Upon receiving the person's signature, the method 100 compares a characteristic of the person's signature to a characteristic of a signature stored within the memory of the wireless mobile station 10 at block 104. The method 100 then transmits a signal verifying the authenticity of the person's signature at block 106. The verification signal is transmitted if the characteristic of the person's signature matches the characteristic of the stored signature. Further explanation of the method 100 will be described in relation to FIG. 3 below.

FIG. 3 is a diagram illustrating an exemplary system 200 for verifying a person's signature. The system 200 includes a memory 202, a receiver 204, a comparator 206 and a transmitter 208. All or part of the system 200 and its functions may be implemented as hardware, software or firmware, though preferably the system 200 is implemented as software on the wireless mobile station 10. The system 200 may further be implemented in one or more routines, such as those described below, for the receiving, comparing and verification of a signature.

The memory 202 may be any kind of memory used with a wireless mobile station 10, such as magnetic memory, optical memory, magnetic or optical hard drives, static memory, dynamic memory, EPROM chips, etc. In one example, the memory 202 is a subscriber identity module (SIM) which may commonly be found in many types of wireless mobile stations 10. The SIM is generally designed to hold most of a user's personal information such as telephone numbers, datebooks, information about the wireless mobile station 10, etc. The SIM also generally has built-in security functions that locks out a user from the stored information unless the appropriate password or code is entered.

Generally, the memory 202 stores one or more signatures. The stored signatures are those of the credit card holder, account holder or whoever's signature is being used as the reference signature. Usually, the reference signature belongs to the same person who owns the wireless mobile station 10 or otherwise regularly uses the wireless mobile station 10. Therefore, the wireless mobile station 10 may be owned by or under the name of one person, but is regularly used by or shared with a family member, whose signature is then stored in the wireless mobile station 10. In another example, a credit card or an account may be jointly held by two or more persons where either's signature may be used to authorize a transaction. Therefore, the memory 202 may hold signatures belonging more than one person. Each signature may further be associated with particular accounts. For instance, one user may have one credit card account and another user has another separate credit card account, where each user's signature will only work with their own account.

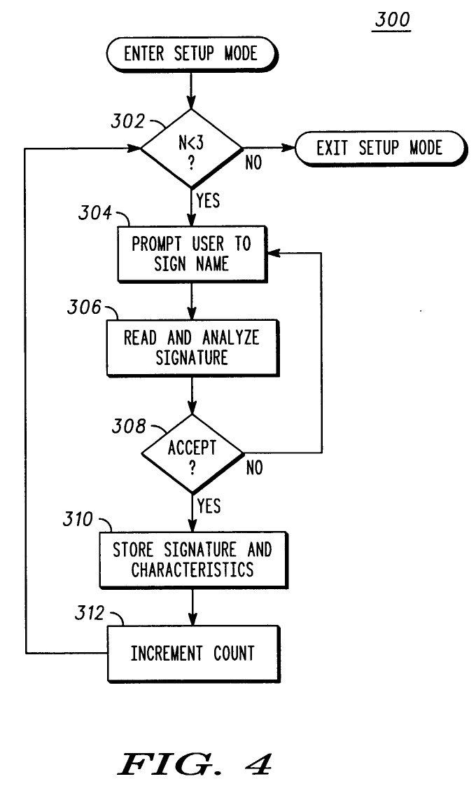

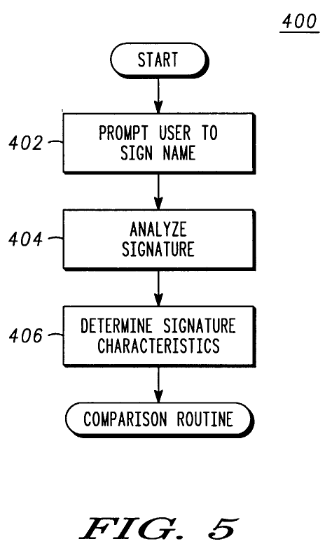

In order to store the signature(s), an initialization routine 300 as shown in FIG. 4 may be used. When a user first receives the wireless mobile station 10, the initialization routine 300 may be included as part of an initial setup mode or initialization where the user is prompted to input personal information and preferences. However, the initialization routine 300 may be accessed at other times whenever the user wishes to update the stored signatures.

Upon entering the setup mode, the initialization routine 300 checks to see if any signatures have been stored in the memory 202 at block 302. In this example, the memory 202 is able to store three signatures, though the memory 202 may be able to store more or less signatures as required. If three or more signatures are already stored in the memory 202, the initialization routine 300 will exit. Otherwise, if there are less than three signatures stored in the memory 202, the initialization routine 300 prompts the user to enter his or her signature at block 304.

As mentioned above, the wireless mobile station 10 may include a touchpad 14, though for purposes of initially entering signatures, the wireless mobile station 10 may be communicatively coupled to a touchpad for only the input of the user's signature rather than having a touchpad 14 built into the wireless mobile station 10 permanently. The user signs his name on the touchpad 14 using a stylus or other device for writing. The touchpad 14 reads and analyzes the signature at block 306, to determine how the signature was made (e.g., pressure, speed, etc.). Any number of characteristics about the signature may be read by the touchpad 14 and its associated software. The software may be handwriting recognition software, as known by those of ordinary skill in the art. Just as handwriting software can be taught to associate a person's handwriting with certain words and letters, the handwriting recognition software may be taught to associate the user's signature with the user's name or some other form of user identification such as a secret code or number that is randomly assigned during the initial setup. In this example, the characteristic of the signature is the signature itself because the signature in its entirety may be associated with the user's identity as opposed to specific aspects of the signature.

Alternatively, the software used to read and analyze the user's signature may be a form of biometrics software or signature recognition software which may take a much more detailed reading of the user's signature. The signature recognition software may read various characteristics of the user's signature ranging from the slope of the lettering to connection points where a user pauses or changes direction with the stroke of the pen. Biometrics software would be able to read how a signature was made, for example by reading how much pressure the user uses to write the signature and how the pressure varies over the course of the signature. Other characteristics that may be read by either form of software may include the loops in certain letters, the speed or variations in speed the signature is written in, timing, shape, cross-strokes, upstrokes, downstrokes, slope, spacing, size, placement, connection points, handwriting style or any other characteristics of a signature that can be from a signature. In one example, a mapping function may be used to identify particular points in the received signature where measurements of pressure, etc. are taken. These same points may be used for reference measurements with respect to other points mapped onto the signature to determine characteristics such as slope, size, speed between points, etc. Together, these characteristics include information on how the signature looks, how it was made and the movements used by the user to make the signature.

Once the signature has been written, the user is allowed to inspect the signature at block 308. The user if afforded an opportunity to review his signature entry and if the user is not satisfied with the signature, he may reject it and re-enter his signature at block 304. If the user is satisfied with the signature, the signature is stored at block 310 in the memory 202. The count is incremented at block 312 and the initialization routine 300 returns to block 302 for entry of another signature or to exit the initialization routine 300.

In the present example, the user is given three opportunities to enter his signature, because a person generally does not sign exactly the same way each time. Generally, only certain characteristics are common to each signature the user writes. Therefore, it may be necessary to enter the signature more than once. As part of reading the signature at block 306, the initialization routine 300 may look for commonalities among all entries of the user's signature. For example, the first letter in the user's signature may have a particular loop, cross-stroke or other characteristic that is repeated in virtually every incarnation of the user's signature. The user may also tend to apply greater pressure and deliberation at the beginning of each signature with the end of each signature written faster and with less pressure. The initialization routine 300 may note these commonalities and make a note of this to be stored in the memory 202 that will be accessed as a characteristic to be compared with later on. The memory 202 may therefore hold not only the signature itself, but also the various characteristics of the signature including characteristics that are found to be common among each of the signatures stored in the memory 202. In addition, the initialization routine 300 may determine that a characteristic has a range of values. For example, a user may not write his signature with the same amount of pressure at a particular point each time. Therefore, for each signature entered, the initialization routine 300 may measure the amount of pressure at a particular point for each signature and determine a range of pressure measurements that the user applies at that point in each version of his signature. This may be done by taking the high and low values of the pressure measurements so that anything within the range is considered to be a match with that characteristic. Other ranges can be determined by taking the standard deviation from the average or median value, using predetermined deviations from the average or median value, etc.

In addition to storing multiple signatures, the memory 202 may also store signatures of more than one user of the wireless mobile station 10. Each user may go through the initialization routine 300 as described above, and the memory 202 may store the characteristics of each user's signature. When a particular user uses the wireless mobile station 10, he may enter an access code or identification that allows the wireless mobile station to know whose signature(s) to access. Each stored signature or set of signatures may be associated with an account number during the initialization routine 300, so that a particular signature will only work with a particular account number. This allows multiple users to each have their own associated with their own accounts.

Once the initialization routine 300 has been completed, the stored signatures are locked off and/or encrypted to all persons that may come into possession of the wireless mobile station 10. Thus, an unauthorized user may not be allowed to re-write the stored signatures and input his own in their place. The signatures may only be accessed and rewritten by entering a code, password or decryption key known only to the proper user or by erasing and reprogramming the entire memory 202 by an authorized serviceman.

Referring again to FIG. 2, when a person is required to enter a signature to authorize a transaction or for any other purpose requiring an authenticated signature, the person's signature is received at block 102. FIG. 5 depicts an example of a receiving routine 400 that may be used to receive the person's signature for verification and authentication. The receiving routine 400 may be performed by the receiver 204. Upon entering his account information at a checkout terminal, such as sliding a credit card through the magnetic reader 18 or by transferring account information from the wireless mobile station 10 to the checkout terminal via the transponder 12, the wireless mobile station 10 prompts the user to enter his signature on the touchpad 14 of the wireless mobile station 10 at block 402. Alternatively, the user may be prompted to enter his signature on the touchpad 20 coupled to the transponder 12. The received signature may then be transmitted to the wireless mobile station 10, or the routine 400 may continue to analyze the received signature and determine the signature characteristics at the transponder 12 or a processor 16 coupled to the transponder 12. The characteristics may then be transmitted to the wireless mobile station 10 for comparison with the stored signature(s). Therefore, all or part of the receiving routine 400 may be performed at the wireless mobile station 10 and/or the transponder 12.

The receiving routine 400 reads and analyzes the received signature at block 404. Generally, block 404 would entail the same or a similar routine as the method described above which was used to read the signature during the initialization routine 300. For example, a mapping function may be used to identify particular points in the received signature. These may be approximately the same points that were mapped onto the stored signature, or these points may be determined based on an initial analysis of the received signature that looks for distinguishing points of reference and takes measurements of characteristics at and between these points, such as pressure, slope, size, speed, etc. At block 406, the receiving routine 400 may determine various characteristics from the signature based upon the analysis at block 404. This includes not only how the signature looks but also how it was written, including characteristics such as speed, timing and pressure information and variations thereof when writing the signature.

In one example, the receiving routine 400 may determine only those characteristics unique to the stored signature. As mentioned above, the distinguishing feature of the stored signature(s) may be the appearance of the first letter and the pressure and speed used to write the signature. The receiving routine 400 may therefore analyze the received signature to determine only how the first letter appears, the amount of pressure and speed used to write the signature and variations thereof over the course of the signature. Alternatively, the receiving routine 400 may perform a full analysis of the received signature to determine all of its characteristics at block 406, not just those that distinguish the stored signature(s).

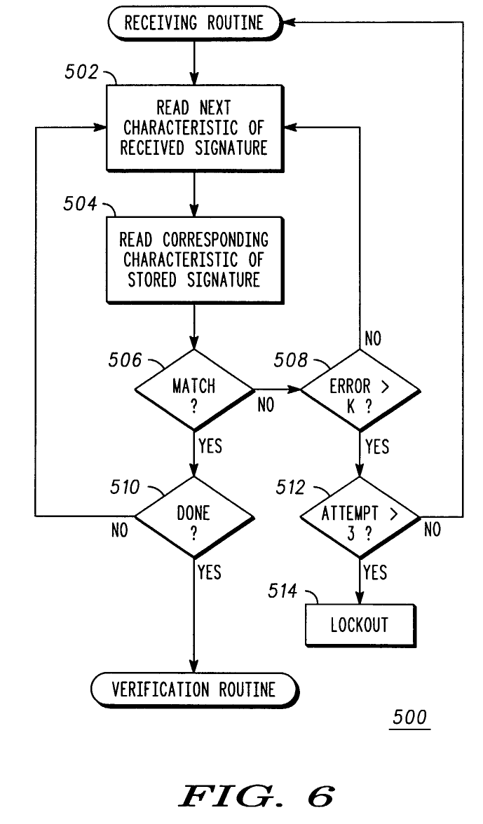

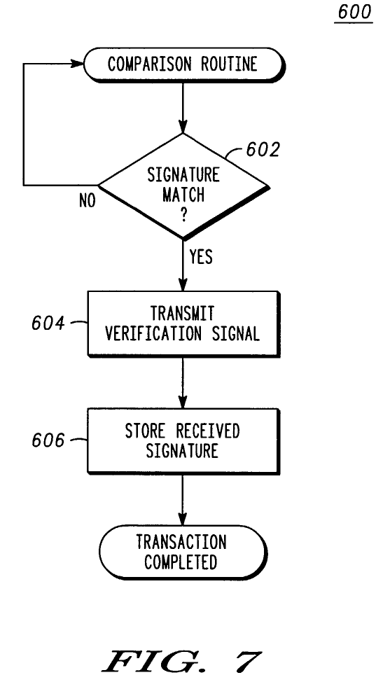

Once a person's signature has been received to authorize a transaction, the method 100 performs a comparison of the signature characteristics at block 104 to determine if the person's signature matches the stored signature. An example of a comparison routine 500 is depicted in FIG. 6 and may be implemented in the comparator 206. Having determined the characteristics of the person's signature, the comparison routine 500 reads one of the characteristics at block 502. The comparison routine 500 then reads a corresponding characteristic of one of the stored signatures. For example, the comparison routine 500 may read how the first letter of the received signature appears at block 502, which may include just an overall appearance of the letter or particulars on the appearance of the letter such as slope, size, etc. The comparison routine 500 also read, at block 504, how the first letter of the stored signature appears using corresponding parameters (e.g., overall appearance, slope, size, etc.).

At block 506, the comparison routine 500 determines if there is a match between the characteristic of the received signature and the characteristic of the stored signature. For example, the comparison routine 500 may compare the appearance of the first letter of each signature by comparing the location of points that have been mapped onto the stored signature with the location of points that have been mapped onto the received signature during the analysis of the receiving routine 400. If the points align, then there is a match. As mentioned above, the initialization routine 300 may determine acceptable ranges that a characteristic of the received signature may fall into and be considered a match. Therefore, at block 506 the determination of whether a match exists or not may be one of degree rather than a strictly exact match. This provides some flexibility for the authorized user to enter his signature, considering each incarnation if his signature is not exactly the same.

The routine 500 may then determine if there are any further characteristics to compare such as pressure, etc. at block 508. If so the comparison routine 500 returns to block 502 to read the next characteristic of the received signature to be compared. This loop may be continued until all characteristics determined in the receiving routine 400 have been compared to corresponding characteristics of the stored signatures. Once this comparison is completed, the comparison routine 500 exits to the verification routine 600 described below. The comparison routine 500 may also be performed for each version of the user's signature that is stored in the memory 202 to provide several comparisons just in case the proper user is using a different signature or if more than one signature may provide authorization (e.g., a jointly shared account).

If there is not a match between the characteristic of the received signature and the corresponding characteristic of the stored signature at block 506, the comparison routine 500 includes this in an characteristic mismatch count that tracks the number of mismatches the comparison routine 500 detects at block 506. At block 510, the comparison routine 500 may check to see if the number of mismatches exceeds a predetermined limit K. If the limit has not been exceeded, the comparison routine 500 reads the next characteristic of the received signature at block 502. Therefore, while a user may not be able to reproduce his signature identically every time, the comparison routine 500 remains flexible by permitting some mismatches between the characteristics of the received signature and the characteristics of the stored signature.

However, should there be too many mismatches, the comparison routine 500 will reject the received signature as being invalid. Alternatively or in addition, the comparison routine 500 may monitor the number of matches from block 506 such that a signature is considered authentic only if there is a minimum number of matches among the characteristics. Additional flexibility in comparing the received signature may be met by comparing the received signature to each of the various stored signatures the user signed and approved in the initialization routine 300. This way, if one signature produces too many mismatches, the comparison routine 500 may compare the next stored signature.

As mentioned above, it is unlikely that a user will duplicate his signature exactly every time. An exact duplicate may be indicative of forgery or an attempt to circumvent the receiving routine 400 and input data to represent characteristics that exactly match those of the stored signature. Therefore, the comparison routine 500 may check to see if there are very little or no mismatches between the received signature and the stored signature. If there are very few or no mismatches, the comparison routine 500 may require the person to re-enter the signature.

If a received signature is rejected as being invalid, the comparison routine 500 checks to see how many attempts have been made by the person to enter his signature for verification at block 512. If the number of attempts is below a certain value, the comparison routine 500 still rejects the received signature but permits the person to re-enter his signature at the receiving routine 400. If the number of attempts to verify the person's signature exceeds a predetermined amount (e.g., three attempts) the comparison routine 500 may prevent the person from attempting to have his signature verified again at block 514. Thus, a person has more than one attempt to enter his signature and have it verified.

However, too many invalid signature attempts may be indicative of an unauthorized user attempting to forge a signature. Therefore, the comparison routine 500 may cause the person to be locked out of attempting to enter his signature or locked out of the wireless mobile station entirely. This may be for a set period of time, such as twenty-four hours, or locked out until reset by an authorized dealer. The person may be prompted for a code, password or form of identification known only to the authorized user that allows the user to enter his signature again. The lockout at block 514 may include a communication with a subscriber service to check to see if the wireless mobile station 10 has been reported lost or stolen by the authorized user. Additionally, the wireless mobile station 10 may alert the recipient of the signature (e.g., a cashier at checkout) that the person may not be the authorized user and to request a form of identification or contact the authorities. The wireless mobile station 10 may also contact the authorities automatically or upon learning if the wireless mobile station 10 has been reported lost or stolen and alert the authorities as to the location of the wireless mobile station 10.

Assuming that the comparison routine 500 has found a match between the received signature and the stored signature, the method 100 transmits a signal verifying the received signature's authenticity. An example of a verification routine 600 is shown in FIG. 7 and may be implemented in the transmitter 208, which in turn may be implemented in the wireless mobile station 10 or the transponder 12. At block 602, the verification routine 600 checks to see if there was a signature match from the comparison routine 500. If not, the method 100 may return to the comparison routine to accept another signature, compare the received signature against another stored signature or otherwise. If there is a signature match, the verification routine 600 transmits a verification signal at block 604 to complete the transaction or otherwise indicate that the received signature is authentic and hence the person signing is the authorized user and owner of the signature. The verification signal may be transmitted from the wireless mobile station 10 to the transponder 12 or from the transponder 12 to a network or central computer. The verification signal may be encoded, encrypted and/or transmitted on random frequencies known only to the transponder 12 to avoid interception and duplication of the verification signal. Public key cryptographic techniques that are well known to those of ordinary skill in the art might be exploited to create a secure interchange of the verification message. The verification signal may simply tell the transponder 12 or network that the signature is authentic. Alternatively, the verification signal may carry account information, or a unique code or password unique to the user that allows access to the account for a transfer of funds from the account to complete the transaction.

In another example, the stored signatures may constantly be updated. Generally, a user's signature and how the signature is written changes over time. Therefore, the verification routine 700 may update the stored signatures at block 606 by storing the received signature if the received signature has been matched to a certain degree with the stored signature. The received signature may simply be stored alongside the other stored signature, or the received signature may replace one of the stored signatures, such as the oldest stored signature or the stored signature that most closely matches the received signature. However, the received signature may only be stored if there is a sufficient degree of differences between the characteristics of the stored signature and the received signature. Therefore, the number of mismatches may be used to determine whether the received signature will be stored as an update of the user's signature.

As mentioned above, the receiving routine 400 may be performed at the transponder 12. The received signature, or data representing the received signature, may be transmitted to the wireless mobile station 10 which may perform the comparison routine 500 and verification routine 600. While either the wireless mobile station 10 or the transponder 12 are capable of performing these routines, it is preferred that at least the comparison routine 500 is performed at the wireless mobile station 10 given the stored signatures are generally stored therein. This provides greater security than having the stored signatures kept in a central database that is accessed by a number of wireless mobile station 10 or transponder 12 that needs to verify a signature, leaving the data open to interception or risking unauthorized access to the central database and hence the signatures of many users.

Of course, the most secure system would have the wireless mobile station 10 receive and compare the signature. As mentioned above, the stored signature would be locked or encrypted in the memory 202 so that even if the wireless mobile station 10 was lost or stolen, a forger would not be able to access with stored signatures without a proper code, password or decryption key. In addition, the receiving routine 400, the comparison routine 500 and the verification routine 600 would all be encoded within the wireless mobile station 10. The wireless mobile station 10 would then only have to provide the verification signal to the transponder 12 indicating verification of the received signature.

While the present invention has been described with reference to specific examples, which are intended to be illustrative only, and not to be limiting of the invention, it will be apparent to those of ordinary skill in the art that changes, additions and/or deletions may be made to the disclosed embodiments without departing from the spirit and scope of the invention.

What is claimed is:

1. A method of authenticating a signature comprising:
receiving a signature at a wireless mobile station;
comparing a first characteristic of the received signature to a first characteristic of a signature stored in a memory of the wireless mobile station; and
transmitting a signal verifying the authenticity of the received signature if the first characteristic of the received signature matches the first characteristic of the stored signature.

2. The method of claim 1, wherein receiving the signature comprises receiving a signal indicative of the received signature at the wireless mobile station from a signature input device other than the wireless mobile station.

3. The method of claim 2, further comprising encrypting the signal indicative of the received signature.

4. The method of claim 1, wherein the wireless mobile station comprises a signature input device and wherein receiving a received signature comprises receiving the received signature from the signature input device.

5. The method of claim 1, wherein the characteristics of the stored signature are encrypted.

6. The method of claim 1, further comprising locking up the wireless mobile station if the first characteristic of the received signature does not match the first characteristic of the stored signature.

7. The method of claim 1, further comprising comparing a second characteristic of the received signature to a second characteristic of the stored signature.

8. The method of claim 6, further comprising preventing receiving of any further signatures if the first characteristic of the received signature matches the first characteristic of the stored signature and the second characteristic of the received signature does not match the second characteristic of the stored signature.

9. The method of claim 6, further comprising storing the received signature in the memory if the first characteristic of the received signature matches the first characteristic of the stored signature and the second characteristic of the received signature does not match the second characteristic of the stored signature.

10. The method of claim 6, further comprising transmitting the signal verifying the authenticity of the received signature if at least one of the first and second characteristics of the received signature respectively match the first and second characteristic of the stored signature.

11. The method of claim 1, further comprising accessing an account if the first characteristic of the received signature matches the first characteristic of the stored signature.

12. An apparatus for authenticating a signature comprising:
a memory arranged to store a signature having a characteristic;
a receiver arranged to receive a signature having a characteristic;
a comparator cooperating with the memory and the receiver to compare the characteristic of the stored signature to the characteristic of the received signature; and
a transmitter cooperating with the comparator to transmit a signal verifying the authenticity of the received signature if the characteristic of the stored signature matches the characteristic of the received signature.

13. The apparatus of claim 10, wherein the memory is a subscriber identity module (SIM).

14. The apparatus of claim 10, wherein the receiver comprises a touch-sensitive pad.

15. The apparatus of claim 10, wherein the comparator comprises a handwriting recognition routine.

16. The apparatus of claim 10, wherein the signal verifying the authenticity of the received signature is one of an infrared signal and a radiowave signal.

17. The apparatus of claim 10, wherein a wireless mobile station comprises at least one of the memory, the receiver, the comparator and the transmitter.

18. The apparatus of claim 10, wherein the characteristic of the received signature comprises the received signature and the characteristic of the stored signature comprises the stored signature.

19. A method of doing business comprising:
receiving a customer's signature at a wireless mobile station;
reading at least one characteristic of the customer's signature from a signature input device;
comparing the at least one characteristic of the customer's signature to at least one characteristic of a stored signature;
transmitting a verification signal from the wireless mobile station if the first characteristic of the received signature matches the first characteristic of the stored signature
completing a transaction upon receipt of the verification signal.

20. The method of claim 19, wherein completing a transaction comprises transferring funds from the customer's account.
